(19) United States
(12) Patent Application Publication
(10) Pub. No.: US 2022/0398219 A1
(43) Pub. Date: Dec. 15, 2022

(54) RESPONSE FEATURE FOR COLLABORATION IN A SHARED FILE

(71) Applicant: Microsoft Technology Licensing, LLC, Redmond, WA (US)

(72) Inventors: Kathryn Veronica Jean SULLIVAN, Redmond, WA (US); Zachary Allen GRISWOLD, Covington, WA (US); Jaime Julia Anne HWACINSKI, Sammamish, WA (US); Geetika SINGLA, Redmond, WA (US); Ian Dwyer CURRY, Seattle, WA (US)

(21) Appl. No.: 17/345,963

(22) Filed: Jun. 11, 2021

(51) Int. Cl. G06F 16/176; G06F 9/445; G06F 3/0482

(52) U.S. Cl. CPC G06F 16/176; G06F 9/44505; G06F 3/0482

(57) ABSTRACT

Aspects of the present disclosure relate to systems and methods for creating response components in a shared file. In one aspect, a response component may be generated in a local instance of a shared file to obtain input from collaborators through other instances of the shared file. The other instances of the shared file may be updated to include the response component. Results data generated by the response component in the other instances of the shared file may be received. An aspect of the shared file based on the received results data may be modified.

### BACKGROUND

Computer and software users have grown accustomed to user-friendly software applications for co-authoring files, documents, messages, and the like. For example, storage providers (e.g., cloud storage providers) provide applications such as word processing applications, spreadsheet applications, electronic slide presentation applications, email applications, chat applications, voice applications, and the like, where users can co-author and collaborate with one another within the applications. As more users share, co-author, and collaborate on documents created with these applications, it becomes increasingly difficult for users to interact and collaborate within an application, stay apprised of changes to the documents, and provide feedback or approval. Current techniques for solving this problem include writing comments, sending emails, and presenting content changes and feedback in the document canvas. As such, interacting with and collaborating in a document may be cumbersome, difficult, and inefficient, ultimately resulting in a lack of participating in document interaction and/or collaboration.

### OVERVIEW

This Overview is provided to introduce a selection of concepts in a simplified form that are further described below in the Detailed Description. This Overview is not intended to identify key features or essential features of the claimed subject matter, nor is it intended to be used as an aid in determining the scope of the claimed subject matter.

In summary, the disclosure generally relates to systems and methods for creating response components in a shared file. In one aspect, a response component may be generated in a local instance of a shared file to obtain input from collaborators through other instances of the shared file. The other instances of the shared file may be updated to include the response component. Results data generated by the response component in the other instances of the shared file may be received.

In another aspect, a response component may be generated in a local instance of a shared file to obtain input from collaborators through other instances of the shared file. The other instances of the shared file may be updated to include the response component. An aspect of the shared file may be modified based on results data generated by the response component in the other instances of the shared file.

In yet another aspect, a response component may be generated in a local instance of a shared file to obtain input from collaborators through other instances of the shared file. The other instances of the shared file may be updated to include the response component. In response to an input received at the response component in at least one instance of the shared file, results data generated by the response component in the at least one instance of the shared file may be received. The results data may be updated in every instance of the shared file via the response component. An action with respect to the shared file may be executed based on the received results data generated by the response component in the at least one instance of the shared file.

### DESCRIPTION OF THE DRAWINGS

The detailed description is made with reference to the accompanying figures. In the figures, the left-most digit(s) of a reference number identifies the figure in which the reference number first appears. The use of the same reference numbers in different instances in the description and the figures may indicate similar or identical items.

FIG. 1 illustrates an exemplary system for creating response components in a shared file, according to an example aspect.

FIG. 2 illustrates one view of a word processing application displayed on a user interface of a client computing device, according to an example aspect.

FIG. 3 illustrates another view of a word processing application displayed on a user interface of a client computing device, according to an example aspect.

FIG. 4 illustrates one view a word processing application and an electronic slide presentation application displayed on a user interface of a client computing device, according to an example aspect.

FIG. 5 illustrates an exemplary method for creating a response component, according to an example aspect.

FIG. 6 illustrates a computing system suitable for implementing the enhanced response component technology disclosed herein, including any of the environments, architectures, elements, processes, user interfaces, and operational scenarios and sequences illustrated in the Figures and discussed below in the Technical Disclosure.

### DETAILED DESCRIPTION

Aspects of the disclosure are generally directed to creating response components in shared files. For example, a response component may be generated in a local instance of a shared file such as a word processing file created by a collaboration application. Generating the response component may be initiated using a menu feature of the shared file. The response component may include configuration data. For example, the response component may be configured with a variety of features and settings. When the response component is generated in the local instance of the shared file, other instances of the shared file may be updated to include the response component.

For example, the response component may be mirrored in the other instances of the shared file such that each instance of the response component is updated to be the same. The response component may obtain input from collaborators through the other instances of the shared file. In one example, the response component may include a response button. A user may click on the response button in an instance of the shared file and the response component may obtain this input. In response to obtaining this input, results data may be generated by the response component. The results data may be received by one or more instances of the shared file. In one example, an aspect of the shared file may be modified based on the received results data. The results data may be updated in every instance of the shared file via the response component in real-time. The results data may be visible in every instance of the shared file via the response component. In some examples, the response component is generated in multiple locations of the shared file. In this example, the results data is updated in the response component in the multiple locations of the shared file.

As discussed above, as more users share, co-author, and collaborate on documents created with these applications, it becomes increasingly difficult for users to interact and collaborate within an application, stay apprised of changes to the documents, and provide feedback or approval. Current techniques for solving this problem include writing comments, sending emails, presenting content changes and feedback in the document canvas. As such, interacting with and collaborating in a document may be cumbersome, difficult, and inefficient, ultimately resulting in a lack of participating in document interaction and/or collaboration.

Accordingly, aspects described herein include techniques that make interacting with and collaborating within applications intuitive, user-friendly, and efficient. In one aspect, a response component may be generated in a local instance of a shared file such as a word processing file created by a collaboration application. Generating the response component may be initiated using a menu feature of the shared file. The response component may include configuration data. For example, the response component may be configured to confirm that users/collaborators have read and understood content, collect consensus, gather sign offs, and get feedback from collaborators. In another example, the configuration data may be used to create a response component label, workflow automation, formatting, anonymous voter setting, and notification settings. When the response component is generated in the local instance of the shared file, other instances of the shared file may be updated to include the response component. For example, the response component may be mirrored in the other instances of the shared file such that each instance of the response component is updated to be the same. The updates may flow through the same server or service that synchronizes changes amongst the multiple instances of a shared file. In other implementations, the updates may flow through a relay service that is out-of-band with respect to the shared file service. That is, the multiple instances of the response component hosted in each instance of the shared file may communicate with each other through a relay service that is separate from the service that hosts and synchronizes the shared filed.

With that said, state changes to the response components may trigger other changes to the shared file that cause the other changes to be propagated through the shared file service to the multiple instances of the shared file. Indeed, even a change in state to a response component may be considered a change to the shared file, in which case the state change is not only synchronized through the relay service but is also synchronized through the shared file service. Such double-syncing may be disabled in some implementations or performed only upon saving changes to a shared file to persistent storage (i.e., when it is closed).

The response component may obtain input from collaborators through the other instances of the shared file. In one example, the response component may include a response button. A user may click on the response button in an instance of the shared file and the response component may obtain this input. In another example, the response component may include a mini form. The mini form may be used to create a survey. In this example, the input obtained by the response component may include answers input to the survey by users/collaborators of the shared file. In response to obtaining this input, results data may be generated by the response component. The results data may be received by one or more instances of the shared file.

In one example, an aspect of the shared file may be modified based on results data generated by the response component in the other instances of the shared file. The results data may be updated in every instance of the shared file via the response component in real-time. The results data may be visible in every instance of the shared file via the response component. In one example, an instruction from the response component may be received to modify the aspect of the shared file. In another example, results data may be received to modify the aspect of the shared file. In yet another example, an action with respect to the shared file may be executed based on the results data generated by the response component. An additional response component may be generated in the local instance of the shared file. The other instances of the shared file may be updated to include the additional response component. For example, the response component may be located at the beginning and end of the shared file. Both instances/locations of the response component are updated to include the results data. The results data may be updated in every instance of the shared file via the response component in response to at least one input received at the response component from at least one of the collaborators of the shared file. In some examples, the results data is accessible in a location in addition to the response component in the shared file. For example, a user may access the results data in a dashboard without needing to open the shared file. The results data is updated in every instance of the shared file via the response component via a relay server. In this regard, whether the results data is hosted by the shared file or another location, the results data may be updated in all instances of the response component in real-time. In turn, a user and/or collaborator of the shared file may quickly, intuitively, and efficiently provide input to the shared file, interact with the shared file, and receive feedback such as confirmations, consensus, sign offs, authorization, approvals, and the like while collaborating within applications.

As such, a technical effect that may be appreciated is that response components are created and results data is updated in a clear and understandable manner and on a functional surface so that a user may quickly and efficiently understand, identify, interact with, vote and receive feedback regarding content of the shared file. Another technical effect that may be appreciated is that users and/or co-authors/collaborators of a file may quickly, easily, and efficiently create, view, and interact with response components and results data while collaborating within applications. Yet another technical effect that may be appreciated is that that the response component integrated with a shared file facilitates efficiently updating results data associated with the response component and the shared file across all instances of the response component and the shared file in multiple locations, across multiple files in real-time and therefore avoids incurring network roundtrip costs and does not affect the data server storage.

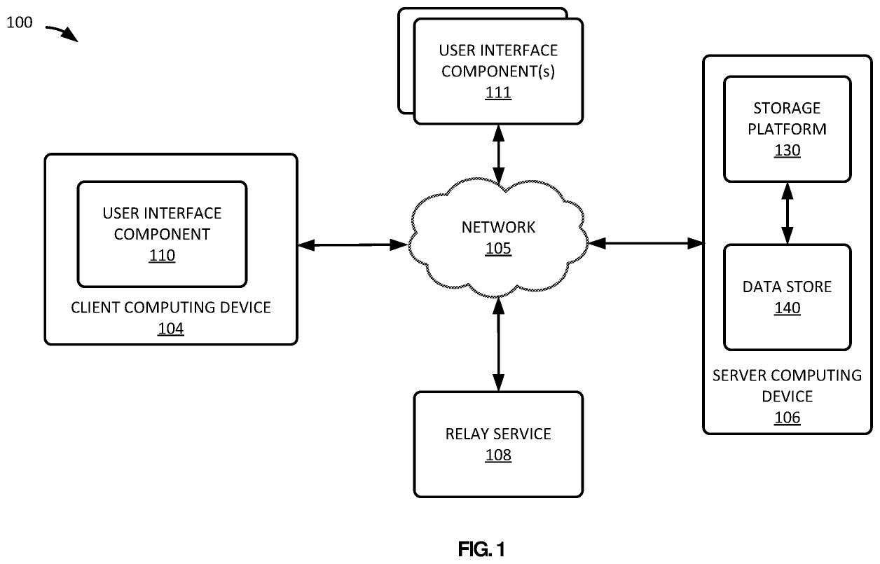

Referring now to the drawings, in which like numerals represent like elements through the several figures, aspects of the present disclosure and the exemplary operating environment will be described. With reference to FIG. 1, one aspect of a file collaboration system 100 for creating response components in shared files is illustrated. The file collaboration system 100 may include a client computing device 104, service relay 108 and a server computing device 106. In aspects, the file collaboration system 100 may be implemented on the client computing device 104. In a basic configuration, the client computing device 104 is a handheld computer having both input elements and output elements. The client computing device 104 may be any suitable computing device for implementing the file collaboration system 100 for creating response components in one or more shared files. For example, the client computing device 104 may be at least one of: a mobile telephone; a smart phone; a tablet; a phablet; a smart watch; a wearable computer; a personal computer; a desktop computer; a laptop computer; a gaming device/computer (e.g., Xbox); a television; etc. This list is exemplary only and should not be considered as limiting. Any suitable client computing device 104 for implementing the file collaboration system 100 for creating response components in one or more shared files may be utilized.

In aspects, the file collaboration system 100 may be implemented on the server computing device 106. The server computing device 106 may provide data to and from the client computing device 104 through a network 105. In aspects, the file collaboration system 100 may be implemented on more than one server computing device 106, such as a plurality of server computing devices 106. As discussed above, the server computing device 106 may provide data to and from the client computing device 104 through the network 105. The data may be communicated over any network suitable to transmit data. In some aspects, the network is a distributed computer network such as the Internet. In this regard, the network may include a Local Area Network (LAN), a Wide Area Network (WAN), the Internet, wireless and wired transmission mediums.

In aspects, at least a portion of the file collaboration system 100 may be implemented on the relay service 108. The relay service 108 may provide data to and from one or more response components on client computing device 104, represented by response component 111. Relay service 108 also provides data to and from other response components on other client devices, represented by response component 113. In other words, relay service 108 relays data between response component 111 and response component 113. At the same time, other components on client computing device 104, such as user interface component 110, may communicate with server computing device 106. In various aspects, the file collaboration system 100 may be implemented on more than one relay service 108, such as a plurality of relay services 108. The relay service 108 may provide data to and from the client computing device 104 and other client computing devices through the network 105. The data communicated by relay service 108 need not traverse server computing device 106. Rather, relay service 108 may be implemented out-of-band with respect to server computing device 106. The data may be communicated over any network suitable to transmit data. In some aspects, the network is a distributed computer network such as the Internet. In this regard, the network may include a Local Area Network (LAN), a Wide Area Network (WAN), the Internet, wireless and wired transmission mediums.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the aspects and functionalities described herein may operate over distributed systems (e.g., cloud-based computing systems), where application functionality, memory, data storage and retrieval, and various processing functions may be operated remotely from each other over a distributed computing network, such as the Internet or an Intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As discussed above, the file collaboration system 100 may include the client computing device 104, the relay service 108 and the server computing device 106, as well as other components on other client computing devices, represented by user interface component 110, response component 111, and response component 113. The various components may be implemented using hardware, software, or a combination of hardware and software. In aspects, the client computing device 104 may include a user interface component 110. The user interface component 110 may facilitate creating one or more response components (e.g., response component 111) in one or more shared files. For example, the user interface component 110 may initiate rendering of a file created with a collaboration application in a user interface of the client computing device 104. In one example, a collaboration application may include any application suitable for collaboration and/or co-authoring such as a word processing application, spreadsheet application, electronic slide presentation application, email application, chat application, voice application, and the like. In one case, a file associated with and/or created with the application may include a word document, a spreadsheet, an electronic slide presentation, an email, a chat conversation, and the like. As such, an exemplary application may be an electronic slide presentation application. In this example, an exemplary file associated with the electronic slide presentation application may include an electronic slide presentation.

In one aspect, the user interface component 110 and/or the file rendered on the user interface may include a menu feature for generating a response component. The menu feature may include a button such as a response button and/or a feedback button. The menu feature may be located in various parts of the file. In one example, the menu feature may be in a ribbon section of the file. The response component may be generated based on an input made with respect to the menu feature. In one example, the input made with respect to the file includes clicking the menu feature (e.g., the response button or feedback button) within the file.

In some examples, the response component may include a button. In this example, the button/response component may be created using at least one of configuration data (e.g., a custom button), and suggested buttons like pre-configured buttons, most recently used buttons, AI buttons, and the like. The suggested buttons may be suggested based on content of the file, the organization the file is associated with, and the like. In one example, the suggested buttons may include buttons such as “approve”, “finished reading”, “like”, “vote” “reject”, “OK”, “accept” and various emojis to name a few.

As discussed above, the button/response component may be created and/or generated using configuration data. The configuration data may include button look and feel data, button labels, workflow automation, formatting, anonymity, and notification settings to name a few. In one example, the button “look and feel” configuration data may be used to customize the response button to match a theme of the file. In one example, the button labels configuration data may be used to customize the label of the button. For example, as discussed above, the response component may be configured to confirm that users/collaborators have read and understood content, collect consensus, gather sign offs, and get feedback from collaborators. In this regard, a custom label such as “Agree to proceed with proposal XYZ” may be created for the response button/component to gather authorization from other users/collaborators of the file. Any variety of customs labels may be created. In other examples, the configuration data may be used to set notifications settings. For example, the response component may be generated to include a notification setting to receive notifications of results data generated by the response component. In another example, the response component may be generated to include a notification setting to receive notifications of any input receive at one or more instances of the response component. In yet another example, the response component may be generated to include a notification setting to not receive any notifications. In other examples, the configuration data may be used to set anonymity. For example, in some scenarios, user's names may be included and displayed in the results data generated by the response component. In this regard, the response component may be generated so that users are anonymous.

In other examples, the configuration data may be used to set rules for formatting. For example, the response component may be generated to include rules for formatting content of the file. The rules may be correlated with the results data generated by the response component. For example, a rule may indicate that a portion of the content will be formatted to be a first color if a majority of collaborators vote yes to an “approve” response button. In another example, the configuration data may be used to set rules for workflow automation. The response component may be generated and/or configured to automate a workflow. Workflow automation may include updating content in the file, sending an email, or filing a bug.

For example, the response component may be configured to have a rule that the content on page 2 of a file is not made visible/available until all users have indicated via the response component that they have read and understand page 1. After all the users/collaborators have indicated via the response component they have read and understand page 1, the file may be modified to include/make available page 2. In this example, the response component may include a suggested response button “finished reading”. As such, after all the collaborators have clicked the “finished reading” button in every instance of the “finished reading” button in every instance of the shared file, page 2 may be made available in every instance of the shared file. Additionally, the results data generated by the response component may be updated in every instance of the “finished reading” button. For example, as collaborators click on their instance of the “finished reading” button, every instance of the “finished reading” button will show these results. In one example, a first collaborator may indicate they have read and understand page 1 of the shared file by clicking the “finished reading” button in their instance of the shared file. Every instance of the “finished reading” button may be updated to indicate or show that the first collaborator has read and understands page 1 of the shared file (e.g., that the first collaborator has “finished reading” page 1). Every instance of the “finished reading” button may be updated to show the name of the first collaborator if the anonymity settings are off. In this regard, as each collaborator indicates they have read and understand page 1 of the shared file by clicking the “finished reading” button in their instance of the shared file, every instance of the “finished reading” button may be updated to indicate or show that each collaborator has read and understands page 1 of the shared file (e.g., that each collaborator has “finished reading” page 1). This results data is updated in real-time as each collaborator clicks the “finished reading” button.

The response component may be generated using the configuration data based on an input made with respect to an edit menu feature. In one example, the input made with respect to the file includes clicking the edit menu feature within the file. In one example, the response component may include a mini form. The mini form may be used to create a survey and/or poll. The survey and/or poll may be configured to obtain input from collaborators/users of a shared file. As discussed above relative to the response component including a button, one or more instances of the shared file may be updated to include the mini form. The results data generated by the mini-form may be updated in one or more instances of the mini-form in the one or more instances of the shared file. The mini form may be configured to confirm that users/collaborators have read and understood content, collect consensus, gather sign offs, for a voting scenario, and get feedback from collaborators. In one example, input may be obtained from collaborators by touching, clicking on, audibly referencing, pointing to, selecting, and/or any indication of an interest in or selection of the response component (e.g., the response button and/or mini form).

In one example, the user interface component 110 may be a touchable user interface that is capable of receiving input via contact with a screen of the client computing device 104, thereby functioning as both an input device and an output device. For example, content may be displayed, or output, on the screen of the client computing device 104 and input may be received by contacting the screen using a stylus or by direct physical contact of a user, e.g., touching the screen. Contact may include, for instance, tapping the screen, using gestures such as swiping or pinching the screen, sketching on the screen, etc.

In another example, the user interface component 110 may be a non-touch user interface. In one case, a tablet device, for example, may be utilized as a non-touch device when it is docked at a docking station (e.g., the tablet device may include a non-touch user interface). In another case, a desktop computer may include a non-touch user interface. In this example, the non-touchable user interface may be capable of receiving input via contact with a screen of the client computing device 104, thereby functioning as both an input device and an output device. For example, content may be displayed, or output, on the screen of the client computing device 104 and input may be received by contacting the screen using a cursor, for example. In this regard, contact may include, for example, placing a cursor on the non-touchable user interface using a device such as a mouse.

In some aspects, the server computing device 106 may include a storage platform 130 and the data store 140. In one example, the storage platform 130 may be configured to store, manage, and access data and/or information associated with the file collaboration system 100. For example, the storage platform 130 may store one or more files in a data store 140. In one example, data store 140 may be part of and/or located at the storage platform 130. In another example, data store 140 may be a separate component and/or may be located separate from the storage platform 130. It is appreciated that although one server computing device 106 is illustrated in FIG. 1, the file collaboration system 100 may include a plurality of server computing devices 106 with a plurality of storage platforms 130 and a plurality of data stores 140. In some cases, the server computing device 106 may include a plurality of storage platforms 130 and a plurality of data stores 140. For example, the plurality of storage platforms 130 may include at least file storage providers, external activity services and document editing clients. In one example, the storage platform 130 may be a cloud storage service such as OneDrive, SharePoint, Google Drive, Dropbox, and the like. In one example, the storage platform 130 may be an email service such as Microsoft Outlook®, Outlook Web App®, Mobile Outlook®, Hotmail®, Outlook.com, as well as any other email service.

As discussed above, a response component may be generated in a local instance of a shared file such as a word processing file created by a collaboration application. When the response component is generated in the local instance of the shared file, other instances of the shared file may be updated to include the response component. In this regard, the other instances of the shared file may be updated to include the response component by propagating the changes via the network 105 at the server computing device 106. The multiple instances of the response component register with relay service 108 so that state information can be relayed between them as their states change, i.e., as users supply input to the prompts indicated by the response buttons. As the response buttons synchronize their state, the change caused by the synchronization may itself represent a change to the shared filed. As such, in some implementations the changes to the shared file may be synchronized through server computing device 106.

In another example, an aspect of the shared file may be modified based on results data generated by the response component in the other instances of the shared file. The modification of the aspect of the shared file may be updated in every instance of the shared file via an application server (e.g., via the server computing device 106). The modification of the aspect of the shared file may include a content modification, a formatting modification, an annotation, and the like. For example, the content modification may include making content available or unavailable for users to view. A paragraph, a page, and the like may be invisible and the aspect of the shared file that is modified may be revealing the paragraph and/or page that is invisible. In this example, in response to the paragraph or page of the shared file being modified every instance of the shared file may be updated to reveal the paragraph or page via the server computing device 106. In another example, the content modification may include deleting content such as a word, sentence, paragraph, and/or page of the shared file. In one example, the formatting modification may include any formatting modification to the shared file. In one example, the layout of the shared file may be modified. In another example, the colors the shared file or at least some of the content of the shared file may be modified.

In one example, an instruction from the response component may be received to modify the aspect of the shared file. For example, as discussed above, results data may be generated by the response component. In this example, the response component may send an instruction based on the results data to the shared file. The instruction may include the modification to the shared file. For example, the instruction may be to delete a paragraph in the shared file. In another example, results data may be received to modify the aspect of the shared file. In this example, the response component may send results data to the shared file. For example, the results data may include: “users have finished reading page 1.” In this example, page 2 may be revealed in the shared file. In yet another example, an action with respect to the shared file may be executed based on the results data generated by the response component. For example, an email may be sent based on the results data generated by the response component. In another example, a bug may be filed based on the results data generated by the response component.

As discussed above, the results data may be updated in every instance of the shared file via the response component in real-time. This is accomplished by the multiple instances of the response component exchanging their states through relay service 108. For example, the response component may be mirrored in the other instances of the shared file such that each instance of the response component is updated to be the same in each instance of the shared file.

In some implementations, each instance of the response component includes both state information and application logic. The response component is executed in the context of a distributed framework on a given client computing device. The framework may be implemented within or external to the context of a productivity application. The logic of the response component determines how the response component is displayed, what text or other visualizations it presents, and how it manages its state.

In a brief example of a voting button, a user interacting with an application creates a response component that represents a voting button in a shared document. The voting button asks a question and provides options for supplying a vote. The user configures the button to be surfaced in the local copies of the shared document such that the users can vote. The button is configured with a list of the users with whom the document has been shared and thus can track the voting states of the other users as they respond to the button.

The response component includes logic that renders the voting button with various voting options. A user toggles or otherwise selects one of the voting options. The response component also includes logic that directs it to accept the user input. The user input changes the state of an instance of the response component and its new state is sent to the other instances of the response button through a relay service. At the same time, the other users are voting in their instances of the response component, changing the states of those response buttons. Eventually, all the votes of all the users are exchanged and synchronized amongst all of the instances of the voting button. The logic in the voting button may then proceed to act based on the voting results. Alternatively, a component of the application that hosts the voting button can act based on the results.

For example, each instance of the voting button may be configured to read the results of the form and to display, respond to the results, and/or retain information indicative of the results. The application that hosts the document can read the results in the voting button and respond accordingly. In other implementations, the application itself may be able to read the form directly and display or otherwise interact with the form and results.

While the response components update each other out-of-band with respect to the shared document, the updated components may represent a change to the document itself, in which case the changed document may be synchronized. This is especially the case when the action triggered by the change in state of a response component changes the underlying document.

The results data may be updated in every instance of the shared file via the response component in response to at least one input received at the response component from at least one of the collaborators of the shared file. In this regard, in response to at least one input received at the response component of at least one instance of the shared file, every instance of the response component in every instance of the shared file is immediately updated via the relay service 108. In one example, the results data may include collaborator's names and vote count information (e.g., a number of votes made). As such, in one example, in response to one collaborator making an input to an instance of the response component, all instances of the response component may be updated with results data that shows the collaborators name and includes a “1” to indicate the one collaborator has made an input (e.g., that one collaborator has voted). As discussed herein, the results data is updated in every instance of the shared file via the response component via the relay server 108 and the modification of the at least one aspect of the shared file is updated in every instance of the shared file via the server computing device 106.

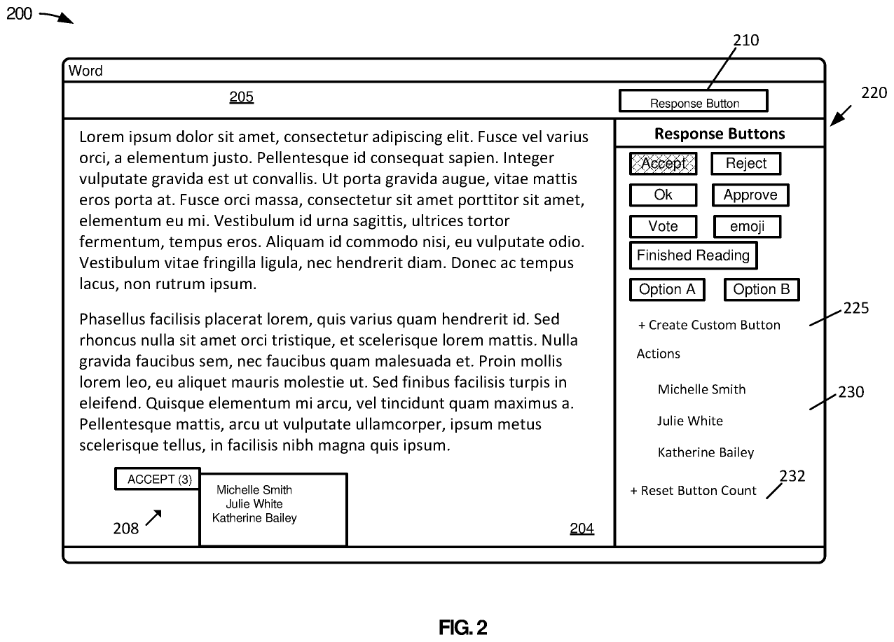

Referring now to FIG. 2, an example view 200 of an application 200 displayed on a user interface of the client computing device 104, such as a desktop computer, tablet computer or a mobile phone, for example, is shown. The exemplary application, as shown in FIG. 2, is a word processing application. In one example, an application may include any application suitable for collaboration and/or co-authoring such as a word processing application, spreadsheet application, electronic slide presentation application, email application, chat application, voice application, and the like. In one case, a file associated with and/or created with the application may include a word document, a spreadsheet, an electronic slide presentation, an email, a chat conversation, and the like. As such, an exemplary application may be a word processing application, as illustrated in FIG. 2. In this example, an exemplary file associated with the word processing application 200 may include a word document.

In aspects, the view 200 of the word processing application 200 is one example view a user may encounter when interacting with the word processing application 200. As illustrated, the exemplary view 200 of the word processing application 200 displayed on the client computing device 104 includes a file 204, a ribbon 205, and a customization panel 220. The various components described herein may be implemented using hardware, software, or a combination of hardware and software. In the exemplary example illustrated in FIG. 2, the file 204 is a word document. As discussed above, the file 204 may be any file of any application suitable for co-authoring and collaboration between one or more users/authors. The file 204 may be a local instance of a shared file. As illustrated in FIG. 2, the file 204 includes a response component 208. As discussed above, the response component 208 may be generated in a local instance of a shared file to obtain input from collaborators through other instances of the shared file. The response component 208 includes an accept button and results data. The results data shows the vote count in the accept button and the names of the users who have voted in a flyout. The vote count indicates the number of collaborators who have voted (e.g., who have made an input to their instance of the response component 208).

As discussed above, generating the response component 208 may be initiated using a menu feature of the shared file. As illustrated in FIG. 2 the ribbon 205 includes the menu feature 210. The menu feature 210 illustrated is a response button. As such, the response component 208 is generated using the menu feature 210. As discussed above, the response component 208 may be configured and/or customized using configuration data. In response to the menu feature 210 (e.g., the response button) being activated (e.g., in response to receiving an indication of interest made with respect to the response button), the customization panel 220 may be displayed. As illustrated in FIG. 2, the customization panel 220 includes the configuration data 225. The configuration data 225 includes the suggestion buttons “approve”, “finished reading”, “emoji”, “vote” “reject”, “Ok”, “accept”, “option A”, and “option B”. In the example of FIG. 2, the “accept” button is selected to configure the response component 208. Additionally, the configuration data 225 includes a create custom button to create a custom button. As illustrated in FIG. 2, the customization panel 220 may include results data 230. As shown, the results data 230 shows the same results shown in the response component 208. Additionally, the customization panel 220 includes a reset button count option 232. The reset button count option 232 may be configured to reset the count number in the results data. The response component 208 and its associated results data is updated in every instance of the response component 208 (not illustrated) as discussed herein.

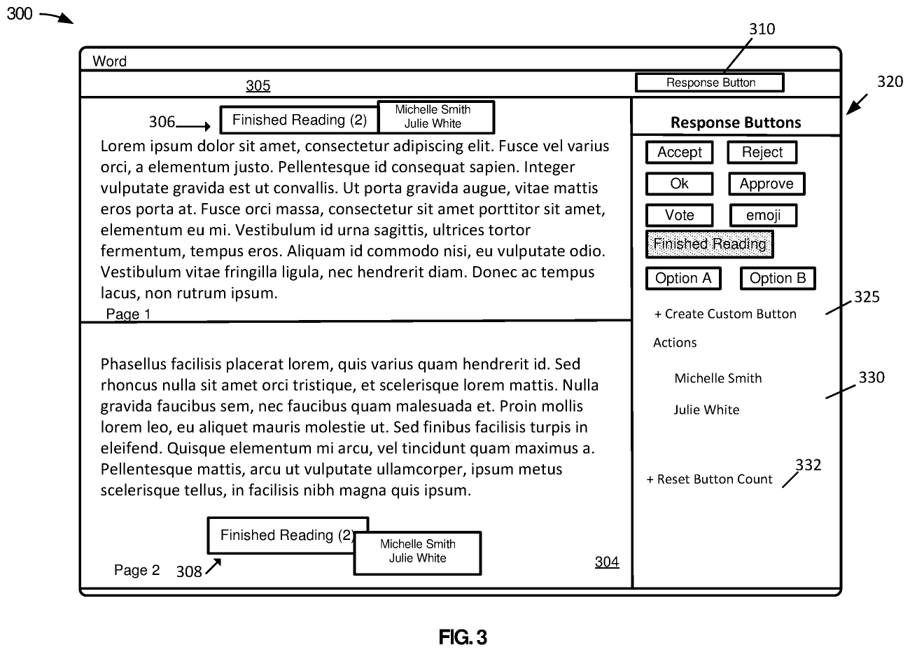

Referring now to FIG. 3, an example view 300 of an application 300 displayed on a user interface of the client computing device 104, such as a desktop computer, tablet computer or a mobile phone, for example, is shown. The exemplary application, as shown in FIG. 3, is a word processing application. In one example, an application may include any application suitable for collaboration and/or co-authoring such as a word processing application, spreadsheet application, electronic slide presentation application, email application, chat application, voice application, and the like. In one case, a file associated with and/or created with the application may include a word document, a spreadsheet, an electronic slide presentation, an email, a chat conversation, and the like. As such, an exemplary application may be a word processing application, as illustrated in FIG. 3. In this example, an exemplary file associated with the word processing application 300 may include a word document.

In aspects, the view 300 of the word processing application 300 is one example view a user may encounter when interacting with the word processing application 300. As illustrated, the exemplary view 300 of the word processing application 300 displayed on the client computing device 104 includes a file 304, a ribbon 305, and a customization panel 320. The various components described herein may be implemented using hardware, software, or a combination of hardware and software. In the exemplary example illustrated in FIG. 3, the file 304 is a word document. As discussed above, the file 304 may be any file of any application suitable for co-authoring and collaboration between one or more users/authors. The file 304 may be a local instance of a shared file. As illustrated in FIG. 3, the file 304 includes a first response component 306 and a second response component 308. As discussed above, a response component may be generated in multiple locations of the shared file. As such, as illustrated in FIG. 3, the first response component 306 and the second response component 308 may be generated in a local instance of a shared file to obtain input from collaborators through other instances of the shared file. The first response component 306 is located at the beginning of the file 304 and the second response component 308 is located at the end of the file 304. Both the first response component 306 and the second response component 308 include a finished reading button and results data. The results data shows the vote count in the finished reading button and the names of the users who have voted in a flyout. The vote count indicates the number of collaborators who have voted (e.g., who have made an input to their instance of either the first response component 306 or the second response component 308). As illustrated in FIG. 3, the results data is updated/mirrored in both the first response component 306 and the second response component 308.

As illustrated in FIG. 3 the ribbon 305 includes the menu feature 310. The menu feature 310 illustrated is a response button. As such, one or both of the first response component 306 and the second response component 308 is generated using the menu feature 310. As discussed above, the first response component 306 and the second response component 308 may be configured and/or customized using configuration data. In response to the menu feature 310 (e.g., the response button) being activated (e.g., in response to receiving an indication of interest made with respect to the response button), the customization panel 320 may be displayed. As illustrated in FIG. 3, the customization panel 320 includes the configuration data 225. The configuration data 325 includes the suggestion buttons “approve”, “finished reading”, “emoji”, “vote” “reject”, “Ok”, “accept”, “option A”, and “option B”. In the example of FIG. 3, the “finished reading” button is selected to configure the first response component 306 and the second response component 308. Additionally, the configuration data 325 includes a create custom button to create a custom button. As illustrated in FIG. 3, the customization panel 320 may include results data 330. As shown, the results data 330 shows the same results shown in the first response component 306 and the second response component 308. Additionally, the customization panel 320 includes a reset button count option 332. The reset button count option 332 may be configured to reset the count number in the results data. As illustrated in FIG. 3 both page 1 and page 2 of the file 304 are available and visible to read. The results data of the first response component 306 and the second response component 308 shows that two collaborators have finished reading. In this example, the first response component 306 and the second response component 308 are configured to reveal page 2 of the file 204 when the two collaborators have finished reading page 1.

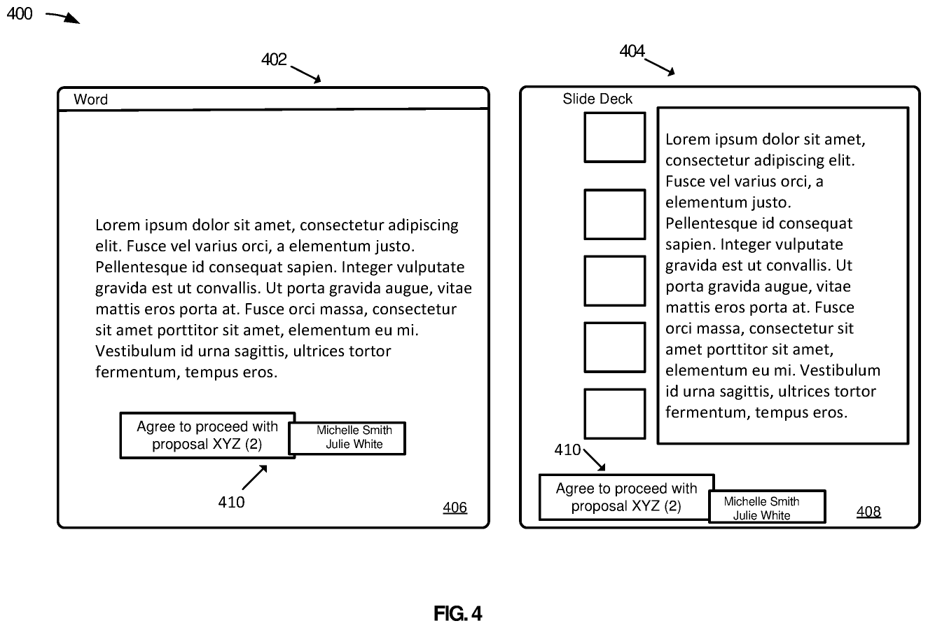

Referring now to FIG. 4, an example view 400 of a first application 402 and a second application 404 displayed on a user interface of the client computing device 104, such as a desktop computer, tablet computer or a mobile phone, for example, is shown. The first exemplary application 402, as shown in FIG. 4, is a word processing application. The second exemplary application 404, as shown in FIG. 4, is an electronic slide presentation application. In one example, an application may include any application suitable for collaboration and/or co-authoring such as a word processing application, spreadsheet application, electronic slide presentation application, email application, chat application, voice application, and the like. In one case, a file associated with and/or created with the application may include a word document, a spreadsheet, an electronic slide presentation, an email, a chat conversation, and the like. As such, an exemplary application may be a word processing application and an electronic slide presentation application, as illustrated in FIG. 4. In this example, an exemplary file associated with the word processing application 402 may include a word document. In this example, an exemplary file associated with the electronic slide presentation application 404 may include a slide deck.

In aspects, the view 400 of the word processing application 402 and electronic slide presentation application 404 is one example view a user may encounter when interacting with the word processing application 402 and the electronic slide presentation application 404. As illustrated, the word processing application 402 displayed on the client computing device 104 includes a file 406. As illustrated, the electronic processing application 404 displayed on the client computing device 104 includes a file 408. The various components described herein may be implemented using hardware, software, or a combination of hardware and software. In the exemplary example illustrated in FIG. 4, the file 406 is a word document and the file 408 is a slide deck. As discussed above, the files 406 and 408 may be any file of any application suitable for co-authoring and collaboration between one or more users/authors. As illustrated in FIG. 4, the file 406 includes a first instance of the response component 410 and the file 408 includes a second instance of the response component 410. As discussed above, a response component may be generated in multiple locations and/or multiple files. As such, as illustrated in FIG. 4, a first instance of the response component 410 is generated in the file 406 and a second instance of the response component 410 is generated in the file 408. As such, the response component 410 is mirrored in the word document 406 and the slide deck 408. In this regard, users may choose which format they want to digest the content in. Furthermore, as illustrated in FIG. 4, the results data is mirrored and updated in real-time in both instances of the response component 410. As shown, the response component 410 includes a custom button. The custom button is a “Agree to proceed with proposal XYZ” button. The results data including the collaborator information and vote count is updated and mirrored in both instances of the response component 410.

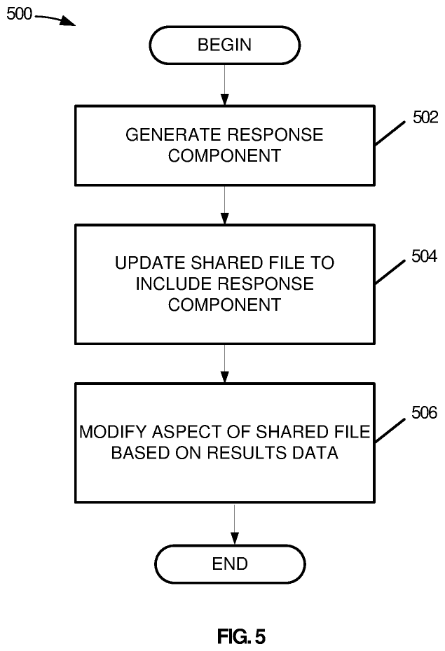

Referring now to FIG. 5, an exemplary method 500 for creating a response component, according to an example aspect is shown. Method 500 may be implemented on a computing device or a similar electronic device capable of executing instructions through at least one processor. For example, the software application may be one of an email application, a social networking application, project management application, a collaboration application, an enterprise management application, a messaging application, a word processing application, a spreadsheet application, a database application, a presentation application, a contacts application, a calendaring application, etc. This list is exemplary only and should not be considered as limiting. Any suitable application for creating a response component may be utilized by method 500, including combinations of the above-listed applications.

Method 500 may begin at operation 502, where a response component is generated in a local instance of a shared file to obtain input from collaborators through other instances of the shared file. In one example, the response component is a mini form for creating a survey and/or poll. In one example, the response component is one of a suggested button or a custom button. In some examples, the response component may generate results data associated with the response component. The results data may be stored at the response component. The response component may be generated in response to a menu feature of the shared file being activated. The menu feature of the shared file may be activated in response to receiving an indication of interest with respect to the menu feature. The menu feature may include a response button or a feedback button. The response component may include configuration data.

When the response component is generated in a local instance of a shared file to obtain input from collaborators through other instances of the shared file, flow proceeds to operation 504 where other instances of the shared file may be updated to include the response component. For example, every instance of the shared file may be updated to include the response component. The response component may generate results data based on input from collaborators of the shared file. In one example, the results data is updated in every instance of the shared file via the response component in real-time through a relay service, out-of-band with respect to the collaboration environment that hosts the shared file. In one example, the results data is visible in every instance of the shared file via the response component. In one example, the results data is updated in every instance of the shared file via the response component in response to at least one input received at the response component from at least one of the collaborators of the shared file.

When other instances of the shared file are updated to include the response component, flow proceeds to operation 506 where an aspect of the shared file is modified based on results data generated by the response component in the other instances of the shared file. In one example, an aspect of the shared file is modified based on results data generated by the response component in the other instances of the shared file by receiving an instruction from the response component to modify the aspect of the shared file. In another example, an aspect of the shared file is modified based on results data generated by the response component in the other instances of the shared file by receiving the results data generated by the response component in the other instances of the shared file to modify the aspect of the shared file. In one example, the modification of the at least one aspect of the shared file is updated in every instance of the shared file.

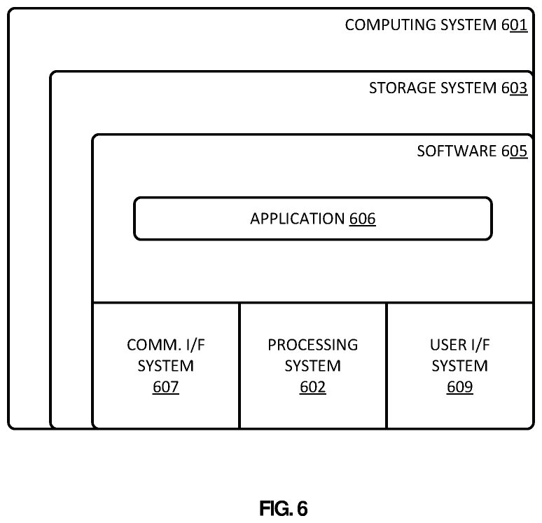

FIG. 6 illustrates computing system 601 that is representative of any system or collection of systems in which the various applications, services, scenarios, and processes disclosed herein may be implemented. Examples of computing system 601 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 601 may be implemented as a single apparatus, system, or device or may be implemented in a distributed manner as multiple apparatuses, systems, or devices. Computing system 601 includes, but is not limited to, processing system 602, storage system 603, software 605, communication interface system 607, and user interface system 609. Processing system 602 is operatively coupled with storage system 603, communication interface system 607, and user interface system 609.

Processing system 602 loads and executes software 605 from storage system 603. Software 605 includes application 606, which is representative of the applications discussed with respect to the preceding FIGS. 1-5, including word processing applications described herein. When executed by processing system 602 to enhance creating response components, software 605 directs processing system 602 to operate as described herein for at least the various processes, operational scenarios, and sequences discussed in the foregoing implementations. Computing system 601 may optionally include additional devices, features, or functionality not discussed for purposes of brevity.

Referring still to FIG. 6, processing system 602 may comprise a micro-processor and other circuitry that retrieves and executes software 605 from storage system 603. Processing system 602 may be implemented within a single processing device but may also be distributed across multiple processing devices or sub-systems that cooperate in executing program instructions. Examples of processing system 602 include general purpose central processing units, application specific processors, and logic devices, as well as any other type of processing device, combinations, or variations thereof.

Storage system 603 may comprise any computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device but may also be implemented across multiple storage devices or sub-systems co-located or distributed relative to each other. Storage system 603 may comprise additional elements, such as a controller, capable of communicating with processing system 602 or possibly other systems.

Software 605 may be implemented in program instructions and among other functions may, when executed by processing system 602, direct processing system 602 to operate as described with respect to the various operational scenarios, sequences, and processes illustrated herein. For example, software 605 may include program instructions for implementing enhanced application collaboration.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software, virtual machine software, or other application software, in addition to or that include application 606. Software 605 may also comprise firmware or some other form of machine-readable processing instructions executable by processing system 602.

In general, software 605 may, when loaded into processing system 602 and executed, transform a suitable apparatus, system, or device (of which computing system 601 is representative) overall from a general-purpose computing system into a special-purpose computing system customized to facilitate enhanced application collaboration. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary storage, as well as other factors.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 609 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 609. In some cases, the input and output devices may be combined in a single device, such as a display capable of displaying images and receiving touch gestures. The aforementioned user input and output devices are well known in the art and need not be discussed at length here.

User interface system 609 may also include associated user interface software executable by processing system 602 in support of the various user input and output devices discussed above. Separately or in conjunction with each other and other hardware and software elements, the user interface software and user interface devices may support a graphical user interface, a natural user interface, or any other type of user interface.

Communication between computing system 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

Among other examples, the present disclosure presents systems comprising one or more computer readable storage media; and program instructions stored on the one or more computer readable storage media that, when executed by at least one processor, cause the at least one processor to at least: generate a response component in a local instance of a shared file to obtain input from collaborators through other instances of the shared file; update the other instances of the shared file to include the response component; and receive results data generated by the response component in the other instances of the shared file. In further examples, the program instructions, when executed by the at least one processor, further cause the at least one processor to modify an aspect of the shared file based on the received results data generated by the response component in the other instances of the shared file. In further examples, the results data is generated based on the input from the collaborators of the shared file. In further examples, the results data is updated in every instance of the shared file via the response component in real-time. In further examples, the results data is visible in every instance of the shared file via the response component. In further examples, the response component includes at least one of a mini-form and a response button. In further examples, the response component is generated in response to a menu feature of the shared file being activated. In further examples, the response component includes configuration data. In further examples, the program instructions, when executed by the at least one processor, further cause the at least one processor to generate the response component in at least two locations of the shared file. In further examples, the results data is updated in the response component in the at least two locations of the shared file.

Further aspects disclosed herein provide an exemplary computer-implemented method for creating a response component, the method comprising: generating the response component in a local instance of a shared file to obtain input from collaborators through other instances of the shared file; updating other instances of the shared file to include the response component; and modifying an aspect of the shared file based on results data generated by the response component in the other instances of the shared file. In further examples, modifying an aspect of the shared file based on results data generated by the response component in the other instances of the shared file comprises receiving an instruction from the response component to modify the aspect of the shared file. In further examples, modifying an aspect of the shared file based on results data generated by the response component in the other instances of the shared file comprises receiving the results data generated by the response component in the other instances of the shared file to modify the aspect of the shared file. In further examples, the computer-implemented method comprises configuring the response component with configuration data. In further examples, the computer-implemented method further comprises: generating an additional response component in the local instance of the shared file to obtain input from the collaborators through the other instances of the shared file; and updating the other instances of the shared file to include the additional response component. In further examples, the results data is updated in every instance of the shared file via the response component in response to at least one input received at the response component from at least one of the collaborators of the shared file. In further examples, the results data is accessible in a location in addition to the response component in the shared file.

Additional aspects disclosed herein provide systems comprising one or more computer readable storage media; and program instructions stored on the one or more computer readable storage media that, when executed by at least one processor, cause the at least one processor to at least: generate a response component in a local instance of a shared file to obtain input from collaborators through other instances of the shared file; update the other instances of the shared file to include the response component; in response to an input received at the response component in at least one instance of the shared file, receive results data generated by the response component in the at least one instance of the shared file, wherein the results data is updated in every instance of the shared file via the response component; and execute an action with respect to the shared file based on the received results data generated by the response component in the at least one instance of the shared file. In further examples, the action executed with respect to the shared file includes a modification of at least one aspect of the shared file, wherein the modification of the at least one aspect of the shared file is updated in every instance of the shared file. In further examples, the results data is updated in every instance of the shared file via the response component via a relay server, and wherein the modification of the at least one aspect of the shared file is updated in every instance of the shared file via an application server.

Techniques for creating a response component are described. Although aspects are described in language specific to structural features and/or methodological acts, it is to be understood that the aspects defined in the appended claims are not necessarily limited to the specific features or acts described above. Rather, the specific features and acts are disclosed as example forms of implementing the claimed aspects.

A number of methods may be implemented to perform the techniques discussed herein. Aspects of the methods may be implemented in hardware, firmware, or software, or a combination thereof. The methods are shown as a set of blocks that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods may be implemented via interaction between various entities discussed above with reference to the touchable user interface.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an aspect with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Additionally, while the aspects may be described in the general context of collaboration systems that execute in conjunction with an application program that runs on an operating system on a computing device, those skilled in the art will recognize that aspects may also be implemented in combination with other program modules. In further aspects, the aspects disclosed herein may be implemented in hardware.

Generally, program modules include routines, programs, components, data structures, and other types of structures that perform particular tasks or implement particular abstract data types. Moreover, those skilled in the art will appreciate that aspects may be practiced with other computer system configurations, including hand-held devices, multiprocessor systems, microprocessor-based or programmable consumer electronics, minicomputers, mainframe computers, and comparable computing devices. Aspects may also be practiced in distributed computing environments where tasks are performed by remote processing devices that are linked through a communications network. In a distributed computing environment, program modules may be located in both local and remote memory storage devices.

Aspects may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or compact servers, an application executed on a single computing device, and comparable systems.

What is claimed is:

1. A system comprising:
one or more computer readable storage media; and
program instructions stored on the one or more computer readable storage media that, when executed by at least one processor, cause the at least one processor to at least:
generate a response component in a local instance of a shared file to obtain input from collaborators through other instances of the shared file;
update the other instances of the shared file to include the response component; and
receive results data generated by the response component in the other instances of the shared file.

2. The system of claim 1, wherein the program instructions, when executed by the at least one processor, further cause the at least one processor to modify an aspect of the shared file based on the received results data generated by the response component in the other instances of the shared file.

3. The system of claim 1, wherein the results data is generated based on the input from the collaborators of the shared file.

4. The system of claim 1, wherein the results data is updated in every instance of the shared file via the response component in real-time.

5. The system of claim 1, wherein the results data is visible in every instance of the shared file via the response component.

6. The system of claim 1, wherein the response component includes at least one of a mini-form and a response button.

7. The system of claim 1, wherein the response component is generated in response to a menu feature of the shared file being activated.

8. The system of claim 1, wherein the response component includes configuration data.

9. The system of claim 1, wherein the program instructions, when executed by the at least one processor, further cause the at least one processor to generate the response component in at least two locations of the shared file.

10. The system of claim 9, wherein the results data is updated in the response component in the at least two locations of the shared file.

11. A computer-implemented method for creating a response component, the method comprising:
generating the response component in a local instance of a shared file to obtain input from collaborators through other instances of the shared file;
updating other instances of the shared file to include the response component; and
modifying an aspect of the shared file based on results data generated by the response component in the other instances of the shared file.

12. The computer-implemented method of claim 11, wherein modifying an aspect of the shared file based on results data generated by the response component in the other instances of the shared file comprises receiving an instruction from the response component to modify the aspect of the shared file.

13. The computer-implemented method of claim 11, wherein modifying an aspect of the shared file based on results data generated by the response component in the other instances of the shared file comprises receiving the results data generated by the response component in the other instances of the shared file to modify the aspect of the shared file.

14. The computer-implemented method of claim 13, further comprising configuring the response component with configuration data.

15. The computer-implemented method of claim 11, further comprising:
generating an additional response component in the local instance of the shared file to obtain input from the collaborators through the other instances of the shared file; and
updating the other instances of the shared file to include the additional response component.

16. The computer-implemented method of claim 11, wherein the results data is updated in every instance of the shared file via the response component in response to at least one input received at the response component from at least one of the collaborators of the shared file.

17. The computer-implemented method of claim 16, wherein the results data is accessible in a location in addition to the response component in the shared file.

18. A system comprising:
one or more computer readable storage media; and
program instructions stored on the one or more computer readable storage media that, when executed by at least one processor, cause the at least one processor to at least:
generate a response component in a local instance of a shared file to obtain input from collaborators through other instances of the shared file;
update the other instances of the shared file to include the response component;
in response to an input received at the response component in at least one instance of the shared file, receive results data generated by the response component in the at least one instance of the shared file, wherein the results data is updated in every instance of the shared file via the response component; and
execute an action with respect to the shared file based on the received results data generated by the response component in the at least one instance of the shared file.

19. The system of claim 18, wherein the action executed with respect to the shared file includes a modification of at least one aspect of the shared file, wherein the modification of the at least one aspect of the shared file is updated in every instance of the shared file.

20. The system of claim 19, wherein the results data is updated in every instance of the shared file via the response component via a relay server, and wherein the modification of the at least one aspect of the shared file is updated in every instance of the shared file via an application server.
